(19) United States
(12) Patent Application Publication
(10) Pub. No.: US 2022/0000001 A1
(43) Pub. Date: Jan. 6, 2022

(54) TINE DISC FOR SPIKE AERATOR

(71) Applicant: Brinly-Hardy Company, Jeffersonville, IN (US)

(72) Inventor: Alexander Carl Hack, Sellersburg, IN (US)

(21) Appl. No.: 17/354,643

(22) Filed: Jun. 22, 2021

Related U.S. Application Data
(60) Provisional application No. 63/047,455, filed on Jul. 2, 2020.

(51) Int. Cl. A01B 45/02

(52) U.S. Cl. CPC A01B 45/02

(57) ABSTRACT

A tine disc comprises a central hub and multiple individual tines extending radially from the central hub, wherein each of the multiple individual tines includes a rib on a surface of the tine, extending from the central hub to a distal end of the tine. In a spike aerator, such tine discs are mounted on a shaft, and the individual tines pierce and penetrate into the soil of the underlying ground surface as the aerator is moved over the underlying ground surface.

### CROSS-REFERENCE TO RELATED APPLICATIONS

The present application claims priority to U.S. Patent Application Ser. No. 63/047,455 filed on Jul. 2, 2020, the entire disclosure of which is incorporated herein by reference.

### BACKGROUND OF THE INVENTION

The present invention relates to an aerator that is used to aerate compacted soil.

When soil becomes compacted, it may be difficult for seed, fertilizer, air, and/or water to penetrate into the soil, and thus, grasses and vegetation do not receive the nutrients necessary for growth. An aerator is thus used to punch holes in soil or pull out plugs of soil.

There are two types of aerators that are commonly used.

A plug (or core-type) aerator includes multiple hollow spikes (or spoons) that are arrayed around a cylindrical drum or shaft. As the aerator is moved over an underlying ground surface, the spikes are rotated into engagement with the underlying ground surface, piercing the ground surface and removing a plug of soil to create a hole.

A spike aerator includes multiple spikes (or tines) that penetrate the underlying ground surface, but these spikes (or tines) effectively create an opening (but do not remove the soil) to create holes as the aerator is moved over the underlying ground surface. In a spike aerator, the spikes (or tines) are typically arrayed about the circumference of tine discs, which are, in turn, mounted along the length of a shaft or a drum. The tine discs rotate as the aerator is moved over the underlying ground surface, and the individual spikes (or tines) pierce and penetrate into the soil of the underlying ground surface.

In spike aerators, the tine discs and individual tines are subjected to significant stress loads, which can bend or otherwise damage the tines. Furthermore, significant weight must be added for the tines to penetrate the soil. This adds stress to the tines and increases the risk of unwanted bending of the tines. The tines might also strike rocks or roots, which also can cause bending of the tines. Increasing the thickness of the tine discs, the individual tines, or the points of the tines can resist some of the bending stresses, but also increases manufacturing costs and can result in undesirable weight increases. Heat-treating the tines can increase their strength, but also increases manufacturing costs. Thus, there remains a need for improved tines that can better manage significant stress loads, but without adding undue weight to the aerator.

### SUMMARY OF THE INVENTION

The present invention is a tine disc for a spike aerator.

An exemplary tine disc has a unitary construction, but may be characterized as including a central hub, with multiple individual tines that extend radially from the central hub. Furthermore, each tine includes a rib on one surface of the tine, extending from the central hub to a distal end (or “point”) of the tine. Each of the tines has a generally triangular shape, such that it has a maximum width at the central hub, and then narrows to a point at its distal end. Each rib also has a generally triangular cross-sectional shape, with a maximum width near the central hub and then narrowing to a point at its distal end. Additionally, the height of each rib decreases along its length from the central hub to its distal end. The cross-sectional shape of the combined tine and rib can also be characterized as having the shape of a chevron, which becomes narrower in width as you advance from the central hub to the distal end. This results from the stamping process that is used to create the rib.

As a result of the above-described construction of the tine disc, it is significantly stiffer or more rigid as compared to a typical flat tine disc, and thus better resists loads that might otherwise bend or damage the tine disc, but without increasing the weight of the tine disc.

The above-described construction of the tine disc also provides another advantage over prior art constructions. In the prior art, tine discs are commonly manufactured from a flat piece of steel; thus, each of the holes made as the tine disc engages the soil has a generally rectangular shape, with a width corresponding to the thickness of the steel used to make the tine disc. However, in the present invention, the inclusion of the rib on the surface of the tine results in an increase in the effective width of the holes made as the tine disc engages the soil. This improves aeration, allowing air and water to move to the root zone much easier, and the hole will exist longer in the soil as it will take longer for it to close as a result of the natural movement of the soil.

An exemplary spike aerator made in accordance with the present invention includes multiple tine discs of the construction described above. Specifically, an exemplary spike aerator includes a frame, which is generally comprised of an upper tray portion, a first end panel, and a second end panel. A first wheel is mounted to the first end panel, and a second wheel is mounted to the second end panel. A tow bar is then mounted to and extends from the frame, such that the spike aerator can be pulled behind a tractor or other vehicle. A shaft is mounted to and rotates with respect to the first end panel and the second end panel. The tine discs are then mounted to and rotate with or around the shaft.

### DESCRIPTION OF THE DRAWINGS

FIG. 1 is a perspective view of an exemplary spike aerator, including multiple tine discs made in accordance with the present invention;

FIG. 1A is a partial exploded perspective view of the exemplary spike aerator of FIG. 1, illustrating how the tine discs and associated bearings are mounted on a shaft of the spike aerator;

FIG. 2 is a perspective view of the assembly of a first bearing, a tine disc, and a second bearing into a modular unit that is then mounted on a shaft of the spike aerator of FIG. 1;

FIG. 3 is a perspective view of an exemplary tine disc of the spike aerator of FIG. 1 in isolation;

FIG. 4 is a top plan view of the exemplary tine disc of FIG. 3;

FIG. 4A is a sectional view of the exemplary tine disc of FIG. 3 taken along line 4A-4A of FIG. 4;

FIG. 4B is a sectional view of the exemplary tine disc of FIG. 3 taken along line 4B-4B of FIG. 4;

FIG. 4C is a sectional view of the exemplary tine disc of FIG. 3 taken along line 4C-4C of FIG. 4;

FIG. 4D is a sectional view of the exemplary tine disc of FIG. 3 taken along line 4D-4D of FIG. 4;

FIG. 4E is a sectional view of the exemplary tine disc of FIG. 3 taken along line 4E-4E of FIG. 4;

FIG. 5 is a bottom plan view of the exemplary tine disc of FIG. 3;

FIG. 6 is an edge view of the exemplary tine disc taken along line 6-6 of FIG. 5;

FIG. 7A illustrates a hole pattern made by a typical tine disc of the prior art; and

FIG. 7B illustrates a hole pattern made by the exemplary tine disc of FIGS. 3-6.

### DETAILED DESCRIPTION OF THE INVENTION

The present invention is a tine disc for a spike aerator.

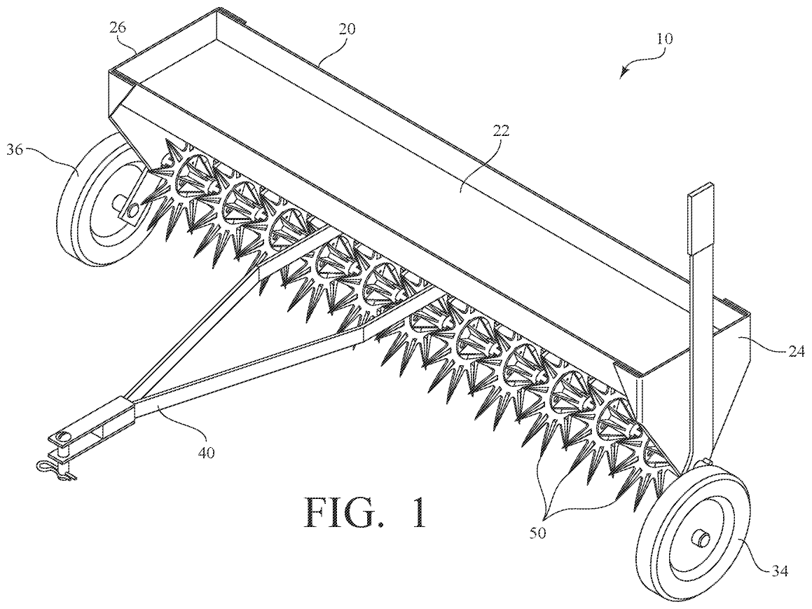

FIG. 1 is a perspective view of an exemplary spike aerator 10, which includes multiple tine discs 50 made in accordance with the present invention. As shown in FIG. 1, the spike aerator 10 includes a frame 20, which is generally comprised of an upper tray portion 22, a first end panel 24, and a second end panel 26. A first wheel 34 is mounted to the first end panel 24, and a second wheel 36 is mounted to the second end panel 26. A tow bar 40 is then mounted to and extends from the frame 20, such that the spike aerator 10 can be pulled behind a tractor or other vehicle.

FIG. 1A is a partial exploded perspective view of the exemplary spike aerator 10, illustrating how the tine discs 50 are mounted on a shaft 28, wherein the shaft 28 is mounted to and rotates with respect to the first end panel 24 and the second end panel 26. Referring now to FIGS. 1 and 1A, the spike aerator 10 includes multiple tine discs 50 that are mounted to and rotate with or around the shaft 28, as further described below. The relative positioning of the tine discs 50 along the length of the shaft 28 is maintained by bearings that are also mounted on the shaft 28.

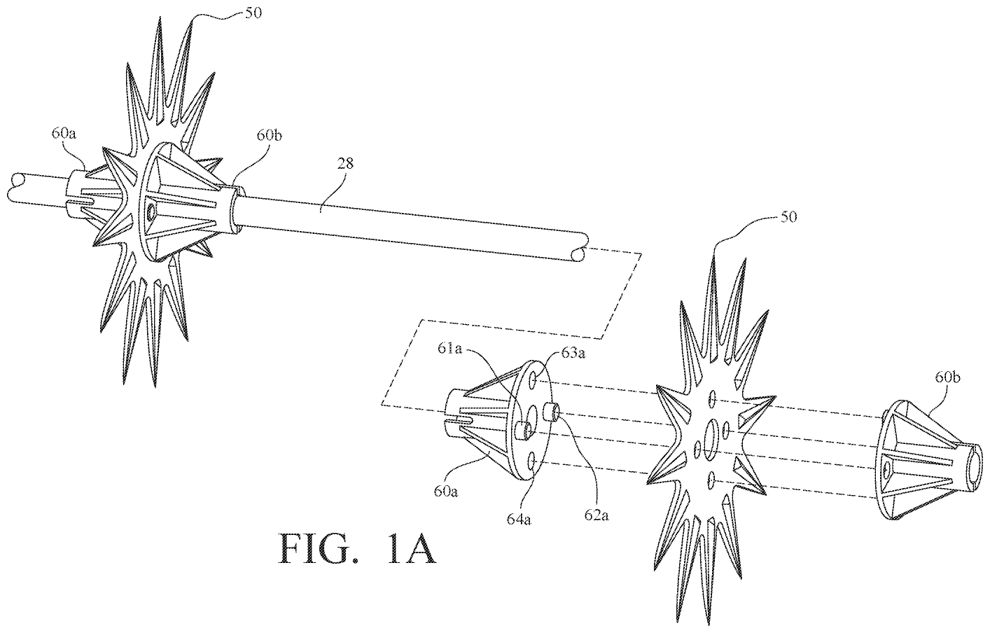

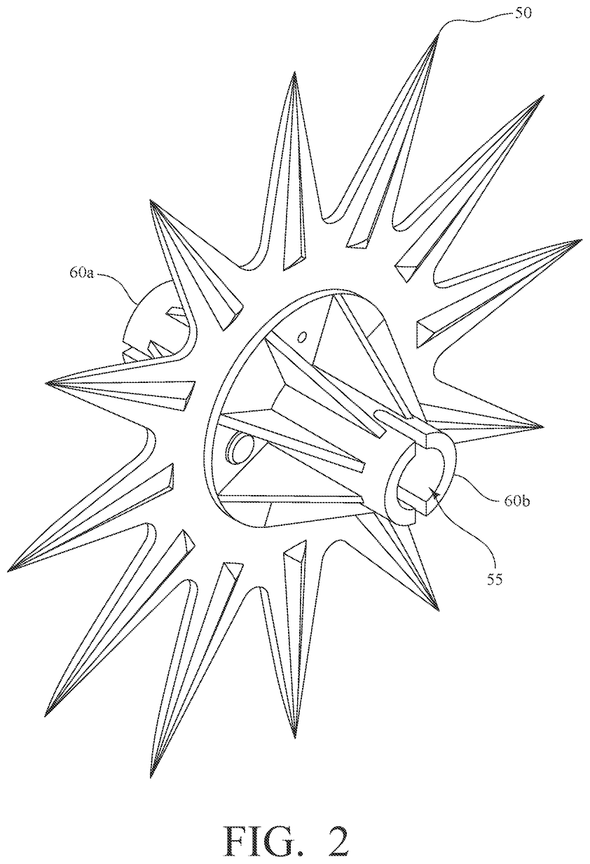

As best shown in FIG. 1A, in this exemplary embodiment, there is a first bearing 60a and a second bearing 60b associated with each tine disc 50, one on each side of the tine disc 50. In this exemplary embodiment, each bearing 60a includes two projections 61a, 62a and defines two openings 63a, 64a. Thus, in assembling the first bearing 60a and the second bearing 60b to the tine disc 50, the projections 61a, 62a of the first bearing 60a are passed through openings defined through the tine disc 50 and into the corresponding openings (not shown in FIG. 1A) defined by the second bearing 60b. Similarly, the projections (not shown in FIG. 1A) of the second bearing 60b are passed through openings defined through the tine disc 50 and into the corresponding openings 63a, 64a defined by the first bearing 60a. This effectively creates a modular unit that consists of the first bearing 60a, the tine disc 50, and the second bearing 60b. FIG. 2 is a perspective view of the assembly of the first bearing 60a, the tine disc 50, and the second bearing 60b into a modular unit. As shown in FIG. 2, there is a central channel 55 defined through the modular unit (i.e. through all three components), such that each of these modular units can be mounted to the shaft 28, creating an array of multiple tine discs 50, extending between the first end panel 24 and the second end panel 26. In this regard, in this exemplary embodiment, there is only a frictional fit between each modular unit and the shaft 28. Therefore, the shaft 28 can rotate with the modular units (i.e., the tine discs 50 and associated bearings), or the modular units can rotate around and relative to the shaft 28. However, in alternative embodiments, the modular units could be keyed or otherwise coupled to the shaft 28, so that all modular units (i.e., the tine discs 50 and associated bearings) and the shaft 28 would effectively rotate together as a single unit.

Although not shown in the FIGS., it should be recognized that, in other embodiments, bolts or similar fasteners could be inserted through the first bearing 60a through openings defined through the tine disc 50 and into the second bearing 60b, or vice versa, to create the modular unit.

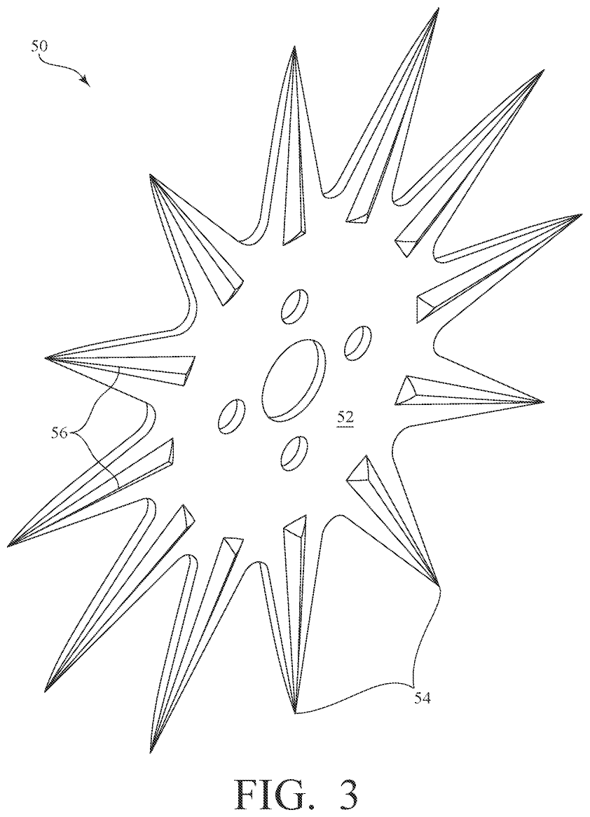

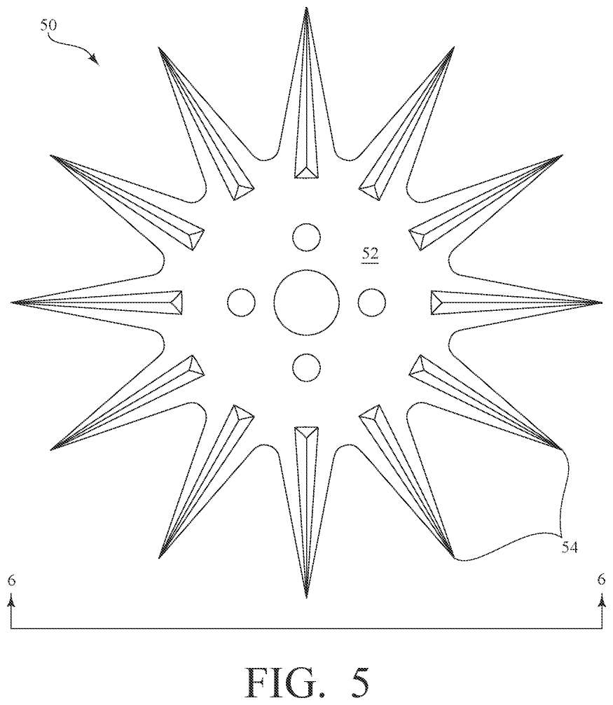

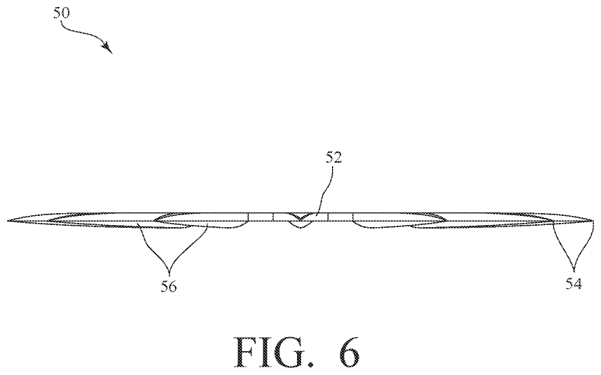

Referring now to FIGS. 3, 4, 4A-4E, 5 and 6, the exemplary tine disc 50 has a unitary construction, but may be characterized as including a central hub 52, with multiple individual tines 54 that extend radially from the central hub 52. Furthermore, each tine 54 includes a rib 56 on one surface of the tine 54, extending from the central hub 52 to a distal end (or “point”) of the tine 54.

As shown in FIGS. 3-5, each of the tines 54 has a generally triangular shape, such that it has a maximum width at the central hub 52, and then narrows to a point at its distal end.

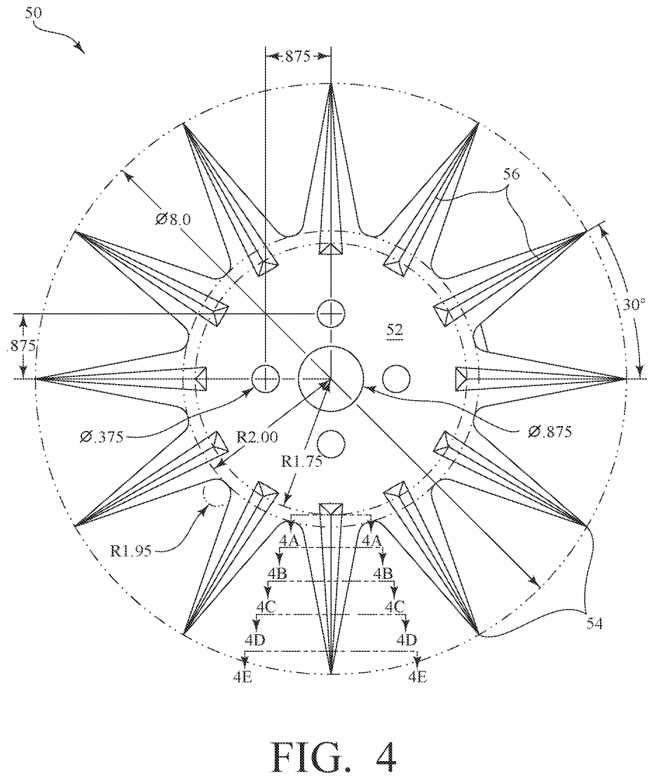

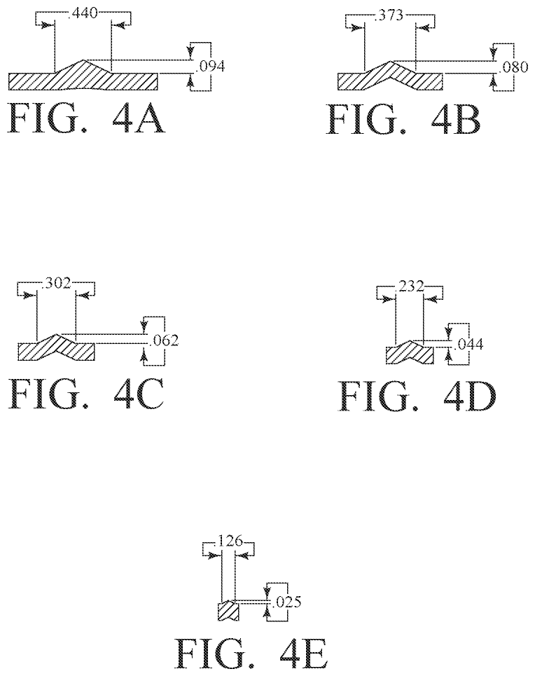

FIG. 4 is a top plan view of the exemplary tine disc 50, including, for sake of example, certain dimensions. FIGS. 4A-4E are various sectional views of the exemplary tine disc 50 that illustrate the changing geometry of the ribs 56.

As shown in FIGS. 4 and 4A-4E, each rib 56 has a generally triangular cross-sectional shape. Each rib 56 has a maximum width near the central hub 52 (FIG. 4A), and then, like the tine 54, narrows to a point at its distal end (FIG. 4E). Furthermore, in this exemplary embodiment, each rib 56 has a width of approximately 0.440 inches near the central hub 52 (FIG. 4A) and narrows to a width of approximately 0.126 inches at its distal end (FIG. 4E). The height of each rib 56 decreases along its length from the central hub 52 to its distal end. In this exemplary embodiment, each rib 56 has a height of approximately 0.094 inches relative to the surface of the tine 54 near the central hub 52 (FIG. 4A) and decreases to a height of approximately 0.025 inches at its distal end (FIG. 4E). Thus, while the tine 54 decreases in dimension in a single plane, the rib 56 decreases in dimension in two planes (width and height).

Referring still to FIG. 4, the cross-sectional shape of the combined tine 54 and rib 56 can also be characterized as having the shape of a chevron, which becomes narrower in width as you advance from the central hub 52 (FIG. 4A) to the distal end (FIG. 4E). This results from the stamping process, which is a preferred method for manufacturing the tine disc 50. In other words, and as shown in FIGS. 3, 4, 4A-4E, 5 and 6, the ribs 56 ribs are stamped into the tine disc 50, such that the ribs 56 project from one surface of the tine disc 50, while there are corresponding depressions in the opposite surface of the tine disc 50.

As a result of the above-described construction of the tine disc 50, it is significantly stiffer or more rigid as compared to a typical flat tine disc, and thus better resists loads that might otherwise bend or damage the tine disc 50. At the same time, additional weight is not added to the spike aerator 10 via the tine discs 50.

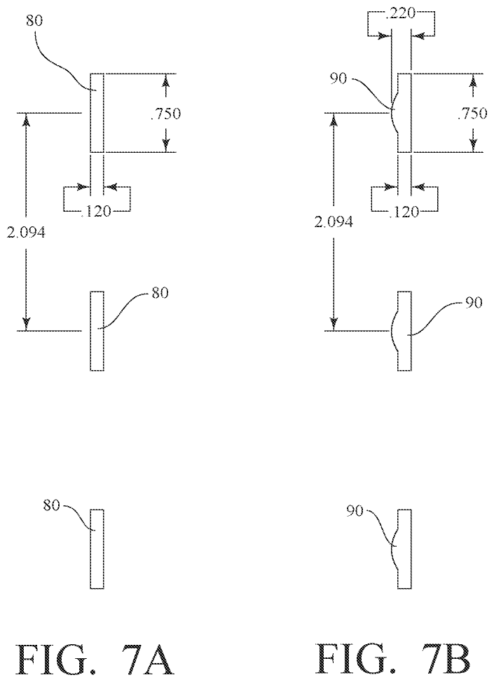

The above-described construction of the tine disc 50 also provides another advantage over prior art constructions. In the prior art, tine discs are commonly manufactured from a flat piece of steel. FIG. 7A illustrates a hole pattern made by such a tine disc as it engages the soil of an underlying ground surface. As shown, each of the holes 80 made as the tine disc engages the soil has a generally rectangular shape, with a width of 0.120 inches, which would correspond to the thickness of the steel used to make the tine disc. FIG. 7B illustrates a hole pattern made by the exemplary tine disc 50 of FIGS. 3-6. As shown, each of these holes 90 has an integral “hump,” increasing the width of the center portion of each hole 90. This “hump” results from the rib 56 on the surface of each tine 54. In short, each hole 90 has an effective width that is greater than the thickness of the steel used to make the tine disc 50. This improves aeration, allowing air and water to move to the root zone much easier, and the hole 90 will exist longer in the soil as it will take longer for it to close as a result of the natural movement of the soil. Of course, a similar result could be achieved by increasing the overall thickness of the tine disc, but that would increase not only the weight of each tine disc, but also the cost of the tine disc.

It is also contemplated that similar ribs could be incorporated into other products that include tines. For example, in certain aerators, tine discs may not have a unitary construction, but rather are comprised of discrete tines that are welded, bolted, or otherwise mounted to a central hub, which, in turn, is mounted to a shaft. Such tines could similarly include ribs like those described above with reference to FIGS. 3, 4, 4A-4E, 5 and 6, extending from the central hub to a distal end (or “point”) of the tine. For another example, lawn rollers are often used after seeding to ensure that seeds are pressed into contact with the soil or used after sod has been installed to ensure that the roots of the sod are pressed into contact with the soil. Some such lawn rollers include tines to pierce and aerate the soil. Such tines could similarly include ribs like those described above with reference to FIGS. 3, 4, 4A-4E, 5 and 6. For another example, certain tillers include tilling (or cultivating) tines that are used to lift, break up, and aerate soil. Such tilling (or cultivating) tines could similarly include ribs like those described above with reference to FIGS. 3, 4, 4A-4E, 5 and 6.

One of ordinary skill in the art will recognize that additional embodiments are also possible without departing from the teachings of the present invention. This detailed description, and particularly the specific details of the exemplary embodiment disclosed therein, is given primarily for clarity of understanding, and no unnecessary limitations are to be understood therefrom, for modifications will become obvious to those skilled in the art upon reading this disclosure and may be made without departing from the spirit or scope of the invention.

What is claimed is:

1. A tine disc, comprising:
a central hub; and
multiple individual tines extending radially from the central hub, wherein each of the multiple individual tines includes a rib on a surface of the tine, extending from the central hub to a distal end of the tine.

2. The tine disc as recited in claim 1, wherein each of the multiple individual tines has a triangular shape, such that each of the multiple individual tines has a maximum width at the central hub, and then narrows to a point at the distal end of the tine.

3. The tine disc as recited in claim 2, wherein each rib has a maximum width near the central hub, and then narrows to a point at the distal end of the tine.

4. The tine disc as recited in claim 2, wherein each rib has a maximum height near the central hub and a minimum height near the distal end of the tine.

5. The tine disc as recited in claim 3, wherein each rib has a maximum height near the central hub and a minimum height near the distal end of the tine.

6. The tine disc as recited in claim 1, wherein a cross-sectional shape of each tine, including the rib on the surface of the tine, is in a shape of a chevron.

7. A tine disc, comprising:
a central hub; and
multiple individual tines extending radially from the central hub;
wherein each of the multiple individual tines has a triangular shape, such that each of the multiple individual tines has a maximum width at the central hub, and then narrows to a point at a distal end of the tine;
wherein each of the multiple individual tines includes a rib on a surface of the tine, extending from the central hub to the distal end of the tine;
wherein each rib has a maximum width near the central hub, and then narrows to a point at the distal end of the tine; and
wherein each rib has a maximum height near the central hub and a minimum height near the distal end of the tine.

8. A spike aerator, comprising:
a frame, including an upper tray portion, a first end panel, and a second end panel;
a shaft mounted to and extending between the first and second end panels, the shaft supporting a plurality of tine discs, in which each of the plurality of tine discs includes (i) a central hub, and (ii) multiple individual tines extending radially from the central hub, wherein each of the multiple individual tines includes a rib on a surface of the tine, extending from the central hub to a distal end of the tine.

9. The spike aerator as recited in claim 8, wherein each of the multiple individual tines has a triangular shape, such that each of the multiple individual tines has a maximum width at the central hub, and then narrows to a point at the distal end of the tine.

10. The spike aerator as recited in claim 9, wherein each rib has a maximum width near the central hub, and then narrows to a point at the distal end of the tine.

11. The spike aerator as recited in claim 9, wherein each rib has a maximum height near the central hub and a minimum height near the distal end of the tine.

12. The spike aerator as recited in claim 10, wherein each rib has a maximum height near the central hub and a minimum height near the distal end of the tine.

13. The spike aerator as recited in claim 8, wherein a cross-sectional shape of each tine, including the rib on the surface of the tine, is in a shape of a chevron.
